(19) United States
(12) Patent Application Publication
(10) Pub. No.: US 2023/0061377 A1
(43) Pub. Date: Mar. 2, 2023

(54) PRODUCT RECOGNITION SYSTEM, PRODUCT RECOGNITION APPARATUS, AND METHOD

(71) Applicant: NEC Platforms, Ltd., Kawasaki-shi (JP)

(72) Inventor: Takuro MIYUKI, Kanagawa (JP)

(73) Assignee: NEC Platforms, Ltd., Kawasaki-shi (JP)

(21) Appl. No.: 17/884,778

(22) Filed: Aug. 10, 2022

(30) Foreign Application Priority Data
Aug. 17, 2021 (JP) 2021-132630

(51) Int. Cl. G06Q 20/20; G06V 10/74

(52) U.S. Cl. CPC G06Q 20/208; G06Q 20/202; G06V 10/761

(57) ABSTRACT

A product recognition apparatus includes: an acquisition unit which acquires an image of a plurality of target products; a storage unit which stores a reference image of a product and a product name; a first setting unit which identifies image parts of the target products from the image, calculate, for each of the target products, the degree of similarity, and set a predetermined number of products as candidate products in a descending order of the degrees of similarity; a second setting unit which calculates, for each of the target products, a difference between a first candidate product and a second candidate product, and set a target product based on the difference between the degrees of similarity as a priority target product; and a generation unit which generates a composite image with the image part of each of the priority target products being focused on and a candidate product list.

### INCORPORATION BY REFERENCE

This application is based upon and claims the benefit of priority from Japanese patent application No. 2021-132630, filed on Aug. 17, 2021, the disclosure of which is incorporated herein in its entirety by reference.

### TECHNICAL FIELD

The present disclosure relates to a product recognition system, a product recognition apparatus, a method, and a program.

### BACKGROUND ART

A product recognition system such as a Point Of Sales (POS) system may photograph a target product, perform image recognition processing on the image of the target product, and thus infer the product name or the like of the target product. In Japanese Unexamined Patent Application Publication No. 2018-185553, which is an example of such a product recognition system, features of an image of a target product obtained by image recognition processing are compared with features of images of a plurality of products registered in advance in a product recognition system, and the degree of similarity between the target product and each of the plurality of products registered in advance in the product recognition system is calculated. Then, in Japanese Unexamined Patent Application Publication No. 2018-185553, the product name of one product whose degree of similarity is higher than a predetermined threshold is displayed on a display unit as a candidate for being the target product (hereinafter, candidate product). Further, in Japanese Unexamined Patent Application Publication No. 2018-185553, when there is no product whose degree of similarity is higher than the predetermined threshold, product names of a plurality of products are displayed on the display unit as candidates.

Further, a POS system used in a restaurant or the like may collectively photograph a plurality of foods (target products) placed on a tray, perform image recognition processing on the image of the plurality of target products including the image parts of the plurality of target products, and thus infer the product names of the plurality of target products, and then perform payment processing. In this case, the POS system compares, for each of the plurality of target products, features of an image of a target product with features of images of products registered in advance in a product recognition system. Then the POS system displays, for each of the plurality of target products, a product whose degree of similarity is the highest as the result of inference and displays names of a predetermined number of products in a candidate product list in a descending order in accordance with the degrees of similarity.

However, inferences made by the image recognition processing are not always correct. Therefore, if the result of an inference made on one target product by the image recognition processing is erroneous, a user first performs an operation of selecting, for example, a target product from a plurality of target products in a POS system, causes a candidate product list of the target product to be displayed, and then selects a correct product from this candidate list. But this requires the user to perform an operation including at least two steps. Therefore, there is a problem that operation procedures are complicated.

Further, the technique disclosed in Japanese Unexamined Patent Application Publication No. 2018-185553 assumes a case in which there is only one target product, and does not take into account the possibility that results of inferences made by the image recognition processing may be erroneous.

### SUMMARY

An object of the present disclosure is to provide a product recognition system, a product recognition apparatus, a method, and a program in which the efficiency of operations is improved.

A product recognition system according to the present disclosure is a product recognition system including a product recognition server and a terminal apparatus connected to the product recognition server in such a way that they can communicate with each other, in which the terminal apparatus includes: an imaging unit configured to acquire an image including image parts of a plurality of target products to be registered; and a terminal-side communication unit configured to transmit the image acquired by the imaging unit to the product recognition server, the product recognition server includes: a server-side storage unit configured to store at least a reference image of a product and a product name in association with each other in advance; a first setting unit configured to identify image parts of the plurality of respective target products from the image transmitted from the terminal apparatus, and compare the image part of each of the target products with the reference image, thereby calculating the degree of similarity between the target product and the product stored in the server-side storage unit, and set, for each of the target products, a predetermined number of products as candidate products in a descending order in accordance with the degrees of similarity; a server-side communication unit configured to transmit, for each of the target products, the product names of the candidate products and the degrees of similarity to the terminal apparatus, and the terminal apparatus further includes: a second setting unit configured to calculate, for each of the target products, the difference between the degree of similarity of a first candidate product whose degree of similarity is the highest and the degree of similarity of a second candidate product whose degree of similarity is the second highest, and set the target product that satisfies a predetermined criterion based on the calculated difference between the degrees of similarity as a priority target product; and a generation unit configured to generate a composite image displayed in a predetermined part of a screen of a display unit, the composite image being generated by composing image parts of the plurality of target products in such a way that the image part of each of the priority target products is focused on, and the generation unit further generating a candidate product list displayed in another part of the screen of the display unit, the product names of the candidate products of the priority target product being arranged in the candidate product list in such a way that one of the product names of the candidate products can be selected.

A product recognition apparatus according to the present disclosure includes: an acquisition unit configured to acquire an image including image parts of a plurality of target products to be registered; a storage unit configured to store at least a reference image of a product and a product name in association with each other in advance; a first setting unit configured to identify image parts of the plurality of respective target products from the image acquired by the acquisition unit, and compare the image part of each of the target products with the reference image, thereby calculating the degree of similarity between the target product and the product stored in the storage unit, and set, for each of the target products, a predetermined number of products as candidate products in a descending order in accordance with the degrees of similarity; a second setting unit configured to calculate, for each of the target products, the difference between the degree of similarity of a first candidate product whose degree of similarity is the highest and the degree of similarity of a second candidate product whose degree of similarity is the second highest, and set the target product that satisfies a predetermined criterion based on the calculated difference between the degrees of similarity as a priority target product; and a generation unit configured to generate a composite image displayed in a predetermined part of a screen of a display unit, the composite image being generated by composing image parts of the plurality of target products in such a way that the image part of each of the priority target products is focused on, and the generation unit further generating a candidate product list displayed in another part of the screen of the display unit, the product names of the candidate products of the priority target product being arranged in the candidate product list in such a way that one of the product names of the candidate products can be selected.

In a product recognition method according to the present disclosure, a product recognition apparatus performs the following processing of: acquiring an image including image parts of a plurality of target products to be registered; storing at least a reference image of a product and a product name in association with each other in advance; identifying image parts of the plurality of perspective target products from the acquired image, and comparing, for each of the target products, the image part of the target product with the reference image, thereby calculating the degree of similarity between the target product and the product stored in advance, and setting, for each of the target products, a predetermined number of products as candidate products in a descending order in accordance with the degrees of similarity; calculating, for each of the target products, the difference between the degree of similarity of a first candidate product whose degree of similarity is the highest and the degree of similarity of a second candidate product whose degree of similarity is the second highest, and setting the target product that satisfies a predetermined criterion based on the calculated difference between the degrees of similarity as a priority target product; and generating a composite image displayed in a predetermined part of a screen of a display unit, the composite image being generated by composing image parts of the plurality of target products in such a way that the image part of each of the priority target products is focused on, and a candidate product list displayed in another part of the screen of the display unit, the product names of the candidate products of the priority target product being arranged in the candidate product list in such a way that one of the product names of the candidate products can be selected.

A product recognition program according to the present disclosure causes a product recognition apparatus to execute the processing of: acquiring an image including image parts of a plurality of target products to be registered; storing at least a reference image of a product and a product name in association with each other in advance; identifying image parts of the plurality of perspective target products from the acquired image, and comparing, for each of the target products, the image part of the target product with the reference image, thereby calculating the degree of similarity between the target product and the product that has been stored in advance, and setting, for each of the target products, a predetermined number of products as candidate products in a descending order in accordance with the degrees of similarity; calculating, for each of the target products, the difference between the degree of similarity of a first candidate product whose degree of similarity is the highest and the degree of similarity of a second candidate product whose degree of similarity is the second highest, and setting the target product that satisfies a predetermined criterion based on the calculated difference between the degrees of similarity as a priority target product; and generating a composite image displayed in a predetermined part of a screen of a display unit, the composite image being generated by composing image parts of the plurality of target products in such a way that the image part of each of the priority target products is focused on, and a candidate product list displayed in another part of the screen of the display unit, the product names of the candidate products of the priority target product being arranged in the candidate product list in such a way that one of the product names of the candidate products can be selected.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram showing a configuration of a product recognition apparatus according to a first example embodiment;

FIG. 2 is a block diagram showing a configuration of a product recognition system according to a second example embodiment;

FIG. 3 is a diagram showing one example of a display screen of a product recognition apparatus according to the second example embodiment; and

FIG. 4 is a flowchart showing a product recognition method according to a third example embodiment.

### EXAMPLE EMBODIMENT

Example embodiments will be described below with reference to the drawings. Since the drawings are simple, the technical range of the example embodiments should not be interpreted narrowly on the basis of the description of the drawings. The same elements are denoted by the same reference signs, and repeated descriptions are omitted.

The disclosure will be described by dividing it into a plurality of sections or example embodiments whenever circumstances require it for convenience in the following embodiments. However, unless otherwise particularly specified, these sections or embodiments are not irrelevant to one another. One section or example embodiment is related to modified example, applications, details, supplementary explanations, and the like of some or all of the other ones. When reference is made to the number of elements or the like including the number of pieces, numerical values, quantity, range, etc. in the following embodiments, the number thereof is not limited to a specific number and may be greater than or less than or equal to the specific number unless otherwise particularly specified and definitely limited to the specific number in principle.

Further, in the following example embodiments, components (including operation steps, etc.) are not always essential unless otherwise particularly specified and considered to be definitely essential in principle. Similarly, when reference is made to the shapes, positional relations, or the like of the components or the like in the following example embodiments, they will include ones, for example, substantially approximate or similar in their shapes or the like unless otherwise particularly specified and considered not to be definitely so in principle. This is similarly applied even to the above-described number or the like (including the number of pieces, numerical values, quantity, range, etc.).

### First Example Embodiment

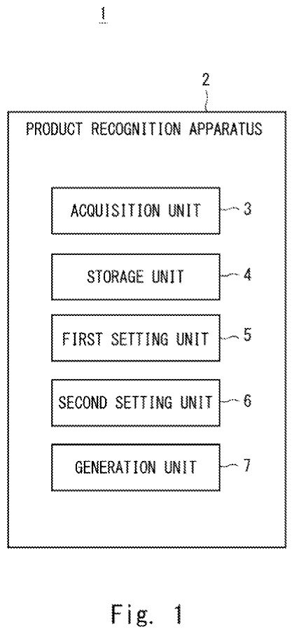

With reference to FIG. 1, this example embodiment will be described. FIG. 1 is a block diagram showing a configuration of a product recognition apparatus 2 according to this example embodiment.

The product recognition apparatus 2 according to this example embodiment includes an acquisition unit 3, a storage unit 4, a first setting unit 5, a second setting unit 6, and a generation unit 7. The product recognition apparatus 2 is an apparatus configured to register information on products in a database. The product recognition apparatus 2, which is, for example, an apparatus that is used in a POS system or the like, recognizes a product at the time when this product is sold, and registers sales data of this product in a sales database.

The acquisition unit 3 acquires an image including image parts of a plurality of target products to be registered. The target products to be registered may be, for example, but not limited to, products which a customer intends to purchase or products which the customer intends to order in a restaurant, etc.

The storage unit 4 stores at least a reference image of a product and a product name in association with each other in advance. It is sufficient that the reference image of the product be an image that is useful to recognize a product and may be, for example, an image obtained by photographing the product from the top or an image obtained by photographing the product from the side.

The first setting unit 5 identifies image parts of the plurality of respective target products from the image acquired by the acquisition unit 3. The first setting unit 5 then compares, for each of the target products, the image part of the target product with the reference image, thereby calculating the degree of similarity between the target product with the product stored in the storage unit 4. Further, the first setting unit 5 sets, for each of the target products, a predetermined number of products as candidate products in a descending order in accordance with the degrees of similarity.

The second setting unit 6 calculates, for each of the target products, the difference between the degree of similarity of the first candidate product whose degree of similarity is the highest and the degree of similarity of the second candidate product whose degree of similarity is the second highest. Then, the second setting unit 6 sets a target product that satisfies a predetermined criterion based on the calculated difference between the degrees of similarity as a priority target product. For example, the second setting unit 6 sets a target product in which the difference between the degrees of similarity is equal to or smaller than a predetermined threshold as the priority target product. Alternatively, the second setting unit 6 sets, for example, a predetermined number of target products as priority target products in an ascending order in accordance with the difference between the degrees of similarity. Note that the “predetermined number”, which is the number of products that the first setting unit 5 sets as candidate products for each of the plurality of target products, and the “predetermined number”, which is the number of target products that the second setting unit 6 sets as priority target products, may either be the same or different from each other.

The generation unit 7 generates a composite image displayed in a predetermined part of a screen of a display unit (not shown) and a candidate product list displayed in another part of the screen. Specifically, the generation unit 7 composes image parts of a plurality of target products in such a way that the image part of each of the priority target products is focused on, thereby generating the composite image. Further, the generation unit 7 generates a candidate product list in which the product names of the candidate products of the priority target product are arranged in such a way that one of them can be selected.

According to this example embodiment, it is possible to provide the product recognition apparatus 2 in which the efficiency of operations is further improved. Specifically, the second setting unit 6 calculates, for each of the target products, the difference between the degree of similarity of the first candidate product and the degree of similarity of the second candidate product, and sets a target product that satisfies a predetermined criterion based on the difference between the degrees of similarity as the priority target product. When, for example, the difference between the degree of similarity of the first candidate product and the degree of similarity of the second candidate product is equal to or smaller than a predetermined threshold regarding one target product, that is, when there is a target product in which the degree of similarity between candidate products is high regarding one target product, the second setting unit 6 sets this target product as the priority target product. Alternatively, the second setting unit 6 sets a predetermined number of target products as priority target products, for example, in an ascending order in accordance with the difference between the degrees of similarity, that is, in a descending order in accordance with the degrees of similarity between candidate products. Then, the generation unit 7 generates a composite image in which the image part of each of the priority target products is focused on and a candidate product list in which product names of the candidate products of the priority target product are arranged in such a way that one of them can be selected. If there are candidate products whose degree of similarity is high regarding one target product, it is possible that the result of the inference by the product recognition apparatus 2 may be erroneous. On the other hand, in this example embodiment, the candidate product list of the target product (priority target product) is automatically displayed on the display unit in preference to the other target products. This eliminates the need for the user to perform an operation for displaying the candidate product list of this priority target product. Accordingly, it is possible to provide the product recognition apparatus 2 in which the efficiency of operations is improved.

### Second Example Embodiment

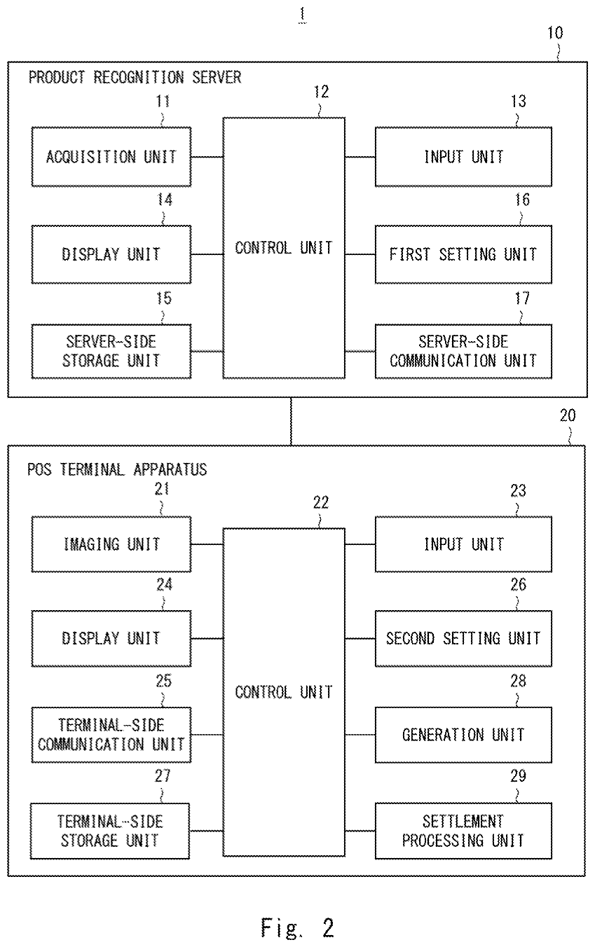

With reference to FIG. 2, this example embodiment will be described. FIG. 2 is a block diagram showing a configuration of a product recognition system 1 according to this example embodiment.

The product recognition system 1 according to this example embodiment is configured as a POS system used in, for example, a restaurant or a supermarket, but it is not limited to this, and a server and a terminal apparatus capable of performing communication may be used. In this example embodiment, the product recognition system 1 includes a product recognition server 10 and a POS terminal apparatus 20. The product recognition server 10 and the POS terminal apparatus 20 can communicate with each other. Further, the product recognition system 1 may include a plurality of POS terminal apparatuses 20. Then, in the product recognition system 1 according to the second example embodiment, a function of the product recognition apparatus 2 according to the first example embodiment is shared by the product recognition server 10 and the POS terminal apparatus 20. For example, the function of the storage unit 4 of the product recognition apparatus 2 according to the first example embodiment is shared by a server-side storage unit 15 (described later) and a terminal-side storage unit 27 (described later).

As shown in FIG. 2, the product recognition server 10 includes an acquisition unit 11, a control unit 12, an input unit 13, a display unit 14, a server-side storage unit 15, a first setting unit 16, and a server-side communication unit 17. The input unit 13 and the display unit 14 may be configured as a display with a touch panel or may be provided separately from each other. As will be described later, the product recognition server 10 identifies an image part of a target product from an image photographed by the POS terminal apparatus 20, and compares the image part of the target product with a reference image (described later) stored in the server-side storage unit 15, thereby calculating the degree of similarity between the target product and the product stored in the server-side storage unit 15. The product recognition server 10 may further include a function for managing various kinds of sales information, such as management of an operation status of the POS terminal apparatus 20.

The acquisition unit 11 acquires an image including the image parts of the plurality of target products, which has been transmitted from the POS terminal apparatus 20. Further, the acquisition unit 11 may further read product identification information such as a barcode or a QR code (registered trademark) of a product from the image part of the target product of the image transmitted from the POS terminal apparatus 20. Further, the acquisition unit 11 may acquire, from the POS terminal apparatus 20, product identification information such as the product barcode read by the POS terminal apparatus 20 from the image including the image parts of the plurality of target products. The acquisition unit 11 may include a camera for photographing a product and may capture an image of the product.

The control unit 12 controls an operation of each unit of the product recognition server 10. The control unit 12 includes a Central Processing Unit (CPU), storage means, an input/output port (I/O), etc. The storage means may be a Read Only Memory (ROM), a Random Access Memory (RAM), etc. Then, the Central Processing Unit (CPU) executes various kinds of programs stored in the storage means, whereby the functions of the control unit 12 are implemented.

The input unit 13 receives an operation instruction from a user. The input unit 13 may be composed of a keyboard or a touch panel display apparatus. The input unit 13 may be composed of a keyboard or a touch panel connected to the product recognition server 10. The input unit 23 of the POS terminal apparatus 20, not the input unit 13, may receive the operation instruction from the user.

The display unit 14 displays the image of the product acquired by the acquisition unit 11. The display unit 14 may display candidates of product names based on feature points of the product calculated in feature point calculation processing by the first setting unit 16. The display unit 14 is composed of various display means such as a Liquid Crystal Display (LCD) and a Light Emitting Diode (LED). The contents displayed by the display unit 14 may be displayed on the display unit 24 of the POS terminal apparatus 20. Further, the contents displayed on the display unit 14 may be displayed on a device such as a mobile phone (including a so-called smartphone) owned by the user.

The server-side storage unit 15 stores at least the reference image of the product and the product name in association with each other in advance. It is sufficient that the reference image of the product be an image useful to recognize the product, such as an image obtained by photographing the product from the top or an image obtained by photographing the product from the side. Further, the server-side storage unit 15 may store product identification information such as a barcode or a QR code (registered trademark) of the product, the reference image of the product, and the product name in association with one another in advance. Further, the server-side storage unit 15 may store a product identification code for identifying the product as the product identification information. That is, the server-side storage unit 15 may store the reference image of the product, the product name, and the product identification code in association with one another in advance. The product identification code may be, for example, a code such as a Price Look Up (PLU) code or a Japanese Article Number (JAN) code for identifying the product. Further, the server-side storage unit 15 may store feature points calculated from the reference image by the first setting unit 16 in association with the reference image of the product, the product name, and the product identification code in advance.

The server-side storage unit 15 may include a non-volatile memory (e.g., Read Only Memory (ROM)) in which various programs and various kinds of data necessary for processing are fixedly stored. The server-side storage unit 15 may be an HDD or SSD. Further, the server-side storage unit 15 may include a volatile memory (e.g., Random Access Memory (RAM)) used as a work area. The program may be read from a portable recording medium such as an optical disk or a semiconductor memory, or may be downloaded from a server apparatus on a network.

The first setting unit 16 calculates feature points in advance from the reference image stored in the server-side storage unit 15.

Further, the first setting unit 16 identifies, from the image that has been acquired by the acquisition unit 11 and includes the image parts of the plurality of target products, the image parts of the plurality of respective target products. Then, the first setting unit 16 compares, for each of the target products, the image part of the target product with the reference image stored in the server-side storage unit 15, thereby calculating the degree of similarity between the target product and the product stored in the server-side storage unit 15.

Specifically, first, the first setting unit 16 identifies, from the image that has been acquired by the acquisition unit 11 and includes the image parts of the plurality of target products, image parts of the respective target products. Next, the first setting unit 16 calculates, for each of the target products, the feature points of the image part of the target product. Next, the first setting unit 16 calculates, for each of the target products, the degree of similarity by comparing the feature points of the image part of the target product with the feature points of the reference image.

Since the processing of identifying the image part of the target product and the processing of calculating feature points from an image in the first setting unit 16 are similar to known image recognition processing, the description of the details thereof will be omitted. Further, the degree of similarity calculated by the first setting unit 16 is also referred to as a “score”.

Further, the first setting unit 16 sets, for each of the target products, a predetermined number of products as candidate products in a descending order in accordance with the degrees of similarity. Then, the first setting unit 16 reads out, for each of the target products, the product names of the candidate products from the server-side storage unit 15. Then, the server-side communication unit 17 transmits, for each of the target products, the product names of the candidate products and the degrees of similarity to the POS terminal apparatus 20. When, for example, the predetermined number is 5, the first setting unit 16 sets, for each of the target products, five products from the one whose degree of similarity is the highest to the one whose degree of similarity is the fifth highest as the candidate products.

The server-side communication unit 17 communicates with the POS terminal apparatus 20. The server-side communication unit 17 may include an antenna (not shown) for performing wireless communication with the POS terminal apparatus 20 or may include an interface such as a Network Interface Card (NIC) for performing wired communication. Then, the server-side communication unit 17 receives the image that has been transmitted from the POS terminal apparatus 20 and includes the image parts of the plurality of target products. Further, the server-side communication unit 17 transmits, for each of the target products, product names of the candidate products and the degrees of similarity to the POS terminal apparatus 20.

The POS terminal apparatus 20 includes an imaging unit 21, a control unit 22, an input unit 23, a display unit 24, a terminal-side communication unit 25, a second setting unit 26, a terminal-side storage unit 27, a generation unit 28, and a payment processing unit 29. The input unit 23 and the display unit 24 may have one configuration as a display with a touch panel or may be provided separately from each other. The POS terminal apparatus 20 is, for example, a dedicated computer installed at a cash register. As will be described later, the POS terminal apparatus 20 photographs a plurality of target products, sets the priority target products based on the degree of similarity transmitted from the product recognition server 10, displays the candidate products of the priority target product in such a way that one of them can be automatically and preferentially selected, and performs payment processing.

The imaging unit 21 collectively photographs a plurality of target products to be registered and acquires an image including the image parts of the plurality of target products. Further, the imaging unit 21 may include a function of reading product identification information such as a barcode or a QR code (registered trademark) of a product. The imaging unit 21 may include a camera for photographing the target product. The image that has been acquired by the imaging unit 21 and includes the image parts of the plurality of target products are transmitted to the product recognition server 10 by the terminal-side communication unit 25.

The control unit 22 controls an operation of each unit of the POS terminal apparatus 20. The control unit 22 includes a Central Processing Unit (CPU), storage means, an input/output port (I/O), etc. The storage means may be a Read Only Memory (ROM), a Random Access Memory (RAM), etc. Then, the Central Processing Unit (CPU) executes various kinds of programs stored in the storage means, whereby the function of the control unit 22 is implemented.

Since the input unit 23 and the display unit 24 have the same functions as those of the input unit 13 and the display unit 14 of the product recognition server 10, respectively, the description thereof will be omitted.

The terminal-side communication unit 25 communicates with the product recognition server 10. The terminal-side communication unit 25 may include an antenna (not shown) for performing wireless communication with the product recognition server 10 or may include an interface such as a Network Interface Card (NIC) for performing wired communication. Then, the terminal-side communication unit 25 transmits the image that has been acquired by the imaging unit 21 and includes the image parts of the plurality of target products to the product recognition server 10. Further, the terminal-side communication unit 25 receives the product names of the candidate products and the degrees of similarity for each of the target products, the product names of the candidate products and the degrees of similarity being transmitted from the product recognition server 10.

The second setting unit 26 calculates, for each of the target products, the difference between the degree of similarity of the first candidate product whose degree of similarity is the highest and the degree of similarity of the second candidate product whose degree of similarity is the second highest. Then, the second setting unit 26 sets a target product that satisfies a predetermined criterion based on the calculated difference between the degrees of similarity as a priority target product. For example, the second setting unit 26 sets a target product in which the difference between the degrees of similarity is equal to or smaller than a predetermined threshold as the priority target product. Alternatively, the second setting unit 26 sets, for example, a predetermined number of target products as the priority target products in an ascending order in accordance with the difference between the degrees of similarity.

When a product has a plurality of sizes, the terminal-side storage unit 27 stores at least the product name and its sizes in association with each other in advance. When, for example, one product has different sizes of large, medium, and small, the terminal-side storage unit 27 stores the product name of this product and its sizes, namely, large, medium, and small in association with in advance.

Since the configuration and the like of the terminal-side storage unit 27 are similar to those of the server-side storage unit 15, the description thereof will be omitted.

The generation unit 28 generates a composite image displayed in a predetermined part of the screen of the display unit 24 and a candidate product list displayed in another part of the screen of the display unit 24.

Specifically, the generation unit 28 composes image parts of the plurality of target products and generates a composite image in such a way that the image part of each of the priority target products is focused on. Here, “the image part of each of the priority target products is focused on” means to make the image part of the priority target product more noticeable than image parts of the other target products. For example, the generation unit 28 composes image parts of the plurality of target products and generates a composite image in such a way that the size of the image part of the priority target product becomes larger than that of the image parts of the other target products.

Further, the generation unit 28 generates a candidate product list in which product names of the candidate products of the priority target product are arranged in such a way that one of them can be selected.

Further, the composite image and the candidate product list generated by the generation unit 28 are displayed on the display unit 24.

Further, when there are a plurality of priority target products, the generation unit 28 may determine the priority target products focused on in the composite image in an ascending order in accordance with the difference between the degrees of similarity calculated by the second setting unit 26. That is, when there are a plurality of priority target products, the generation unit 28 may determine the priority target product whose image part is made larger than image parts of the other target products in the composite image in an ascending order in accordance with the difference between the degrees of similarity calculated by the second setting unit 26. In this case, the generation unit 28 generates a candidate product list of the priority target products focused on in the composite image, and this composite image and the candidate product list are displayed on the display unit 24.

Further, when there are a plurality of priority target products, if the user has selected one of the candidate products from the candidate product list regarding the priority target product that has been focused on first in the composite image, the generation unit 28 may further generate a composite image in which the priority target product in which the difference between the degrees of similarity is the next smallest is focused on. That is, when there are a plurality of priority target products, the generation unit 28 may further generate a composite image by switching the priority target products to be focused on every time the user selects one product name from the candidate product list for one of the priority target products that has been focused in the composite image. In this case, the generation unit 28 further generates a candidate product list of the priority target product newly focused on in the composite image, and the composite image and the candidate product list are displayed on the display unit 24.

Further, when a candidate product has a plurality of sizes, the generation unit 28 may arrange the product name of the candidate product and its sizes in the candidate product list in such a way that each size of the candidate product can be selected.

Further, the generation unit 28 may arrange the product names of the candidate products in the candidate product list in a descending order in accordance with the degrees of similarity in such a way that one of the product names of the candidate products can be selected.

Further, when the generation unit 28 generates a composite image, the generation unit 28 may arrange the product names of the candidate products by superimposing them on the image part of the target product.

Further, the generation unit 28 may further generate a composite image in which the color of the characters indicating the product name selected by the user from the candidate product list among the product names of the candidate products superimposed on the image part of the target product in the composite image is made different from the color of the characters indicating the other product names.

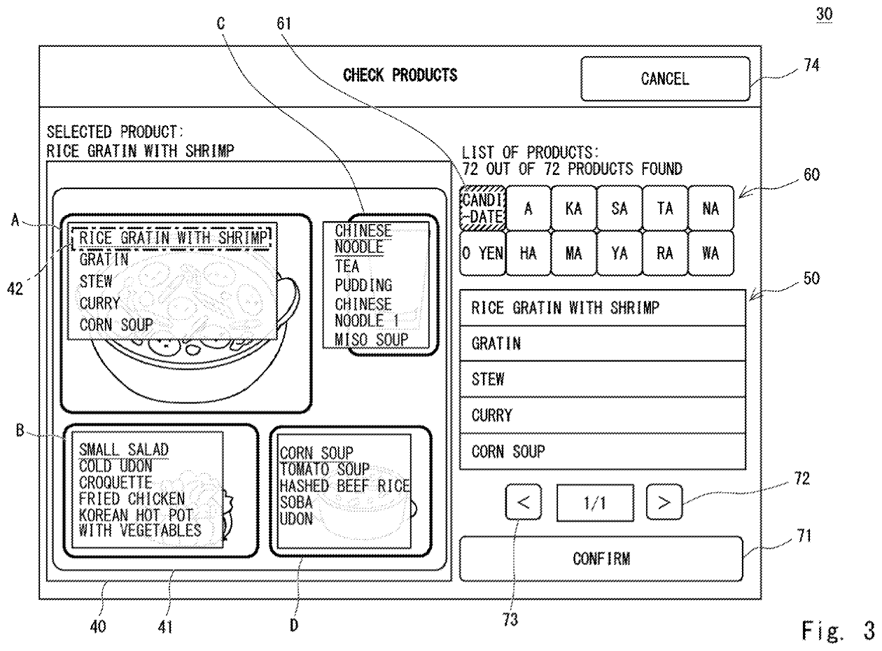

FIG. 3 shows one example of a screen 30 of the display unit 24 that displays a composite image 40 and a candidate product list 50 generated by the generation unit 28. In FIG. 3, the display unit 24 is a touch panel. In the screen 30 shown in FIG. 3, the composite image 40 is displayed on the left side of the screen 30 and the candidate product list 50 is displayed on the right side of the screen 30. In the candidate product list 50, of the candidate products, product names of the first to fifth candidate products are arranged in a descending order in accordance with the degrees of similarity in such a way that one of them can be selected. Further, on the screen 30 shown in FIG. 3, selection buttons 60 for adding candidate products to the candidate product list 50 as a result of an operation by the user are displayed above the candidate product list 50. The selection buttons 60 include the Japanese “A column” button, the Japanese “KA column” button, . . . , the Japanese “WA column” button, a “candidate” button 61, and a “0 yen” button. Then, when the user touches the Japanese “A column” button on the selection buttons 60, product names of the first to fifth candidate products starting from the character of the Japanese “a column” are arranged in the candidate product list 50 in a descending order in accordance with the degrees of similarity in such a way that one of them can be selected. Besides the above elements, images of a “confirm” button 71, a “page up” button 72, a “page down” button 73, a “cancel” button 74 and the like are displayed on the screen 30 shown in FIG. 3.

In the example shown in FIG. 3, when a user (customer) makes a payment using the POS terminal apparatus 20 in a restaurant, the imaging unit 21 photographs a tray 41 on which products to be purchased by the user are placed. It is assumed that four target products A, B, C, and D are placed on the tray 41 and the target product A is “rice gratin with shrimp”, the target product B is “small salad”, the target product C is “Chinese noodle”, and the target product D is “corn soup”.

Then, the first setting unit 16 calculates, for each of the four target products A, B, C, and D, the degree of similarity (score) between the image part and the reference image, and sets a predetermined number of products as candidate products in a descending order in accordance with the degrees of similarity. Further, the first setting unit 16 reads out the product names of the candidate products from the server-side storage unit 15. Table 1 below shows, for each of the four target products A, B, C, and D, product names of five candidate products that the first setting unit 16 has read out from the server-side storage unit 15 and its degrees of similarity (scores) in parentheses.

TABLE 1

| | Product | Product | Product | Product | Product |
|---|---|---|---|---|---|
| | name | name | name | name | name |
| Product | (score) | (score) | (score) | (score) | (score) |
| A | Rice gratin | Gratin | Stew | Curry | Corn soup |
| | with shrimp | (88) | (55) | (50) | (48) |
| | (90) | | | | |
| B | Small salad | Cold udon | Croquette | Fried | Korean hot |
| | (95) | (70) | (60) | chicken | pot with |
| | | | | (55) | vegetables |
| | | | | | (30) |
| C | Chinese | Tea | Pudding | Chinese | Miso soup |
| | noodle | (60) | (55) | noodle 1 | (40) |
| | (90) | | | (55) | |
| D | Corn soup | Tomato | Hashed | Soba | Udon |
| | (88) | soup | beef rice | (45) | (30) |
| | | (85) | (50) | | |

Then, the second setting unit 26 calculates, for each of the target products A, B, C, and D, the difference between the degree of similarity of the first candidate product whose degree of similarity is the highest and the degree of similarity of the second candidate product whose degree of similarity is the second highest. Regarding the target product A, for example, the second setting unit 26 calculates the difference between the degree of similarity of rice gratin with shrimp, which is the first candidate product whose degree of similarity is the highest, and the degree of similarity of gratin, which is the second candidate product whose degree of similarity is the second highest. Then, the second setting unit 26 sets a target product that satisfies a predetermined criterion based on the calculated difference between the degrees of similarity as a priority target product. For example, the second setting unit 26 sets, when the calculated difference between the degrees of similarity is equal to or smaller than a predetermined threshold, this target product as the priority target product. Assume here that the predetermined threshold is “5”. In the target product A, for example, the difference between the degree of similarity of rice gratin with shrimp, which is the first candidate product whose degree of similarity is the highest, and the degree of similarity of gratin, which is the second candidate product whose degree of similarity is the second highest, is “2”, which is smaller than “5”. Therefore, the second setting unit 26 sets the target product A as the priority target product. Further, in the target product D, the difference between the degree of similarity of corn soup and the degree of similarity of tomato soup is “3”, which is smaller than “5”. Therefore, the second setting unit 26 sets the target product D as the priority target product.

Note that the second setting unit 26 may set, for example, a predetermined number of target products as the priority target products in an ascending order in accordance with the difference between the degrees of similarity. In the example shown in FIG. 3, the difference between the degree of similarity of the first candidate product and the degree of similarity of the second candidate product in each of the target products A, B, C, and D is “2”, “25”, “30”, and “3”. That is, the difference between the degrees of similarity increases in the order of the target product A, the target product D, the target product B, and the target product C. If, for example, the “predetermined number” here is set to “3”, the second setting unit 26 may set the top three target products A, D, and B as the priority target products.

Note that the “predetermined number”, which is the number of products set by the first setting unit 16 as the candidate products for each of the four target products A, B, C, and D, and the “predetermined number”, which is the number of target products set by the second setting unit 26 as priority target products, may either be the same or different from each other.

In the following description, an example in which the second setting unit 26 sets a target product in which the difference between the degrees of similarity is equal to or smaller than a predetermined threshold as the priority target product will be described.

The generation unit 28 then generates the composite image 40 and the candidate product list 50. At this time, the generation unit 28 generates the composite image 40, focusing on the target product A set as the priority target product. Specifically, the generation unit 28 generates the composite image 40 in such a way that the image part of the target product A set as the priority target product becomes larger than the image parts of the other products B, C, and D.

In this case, product names of the candidate products of the target product A focused on in the composite image 40, namely, “rice gratin with shrimp”, “gratin”, “stew”, “curry”, and “corn soup” are arranged in the candidate product list 50 in such a way that one of them can be selected.

Further, when the user has selected one of the candidate products (in the example shown in FIG. 3, “rice gratin with shrimp”) from the candidate product list 50 for the target product A focused on in the composite image 40, the generation unit 28 may further generate a composite image 40 in which the target product D set as the priority target product is focused on. In this case, product names of the candidate products of the target product D that has been newly focused on in the composite image 40 are arranged in the candidate product list 50.

Note that the order of target products that are focused on in the composite image 40 may correspond to ascending order in accordance with the difference between the degrees of similarity. In the example shown in the above Table 1, the difference between the degrees of similarity in the target product A is “2” and the difference between the degrees of similarity in the target product D is “3”. Therefore, the order of the target products that are focused on in the composite image 40 is the target product A and then the target product D.

Further, when, for example, a candidate product for a target product has a plurality of sizes, the generation unit 28 arranges the product name of the candidate product and sizes of the candidate product in the candidate product list 50 in such a way that each size of the candidate product can be selected. When, for example, corn soup, which is a candidate product for the target product A, has sizes of “large”, “medium”, and “small”, the generation unit 28 arranges the product name of the candidate product and the sizes of the candidate product in the candidate product list 50; for example, “large corn soup”, “medium corn soup”, and “small corn soup”, in such a way that each size of the candidate product can be selected.

Further, when, for example, the candidate products of the target product A are arranged in the candidate product list 50, the generation unit 28 may arrange the product names of the candidate products in a descending order in accordance with the degrees of similarity in such a way that one of them can be selected. In the example shown in FIG. 3, in the candidate product list 50, “rice gratin with shrimp”, “gratin”, “stew”, “curry”, and “corn soup” are arranged in the candidate product list 50 in a descending order in accordance with the degrees of similarity in such a way that one of them can be selected.

Further, the generation unit 28 may arrange the product names of the candidate products by superimposing them on the image part of the target product of the composite image 40. In the example shown in FIG. 3, in the composite image 40, the product names of the candidate products of the target product A are superimposed on the image part of the target product A, the product names of the candidate products of the target product B are superimposed on the image part of the target product B, the product names of the candidate products of the target product C are superimposed on the image part of the target product C, and the product names of the candidate products of the target product D are superimposed on the image part of the target product D. At this time, as shown in FIG. 3, the generation unit 28 may underline the product name of the candidate product whose degree of similarity is the highest among the product names of the candidate products superimposed on the image part of the target product of the composite image 40.

Further, when, for example, “rice gratin with shrimp” has been selected by the user from the candidate product list 50 for the target product A, the generation unit 28 may further generate a composite image 40 in which, of the product names of the candidate products superimposed on the image part of the target product A of the composite image 40, the color of the characters “rice gratin with shrimp” indicating the product name of the candidate product selected by the user is made different from the color of characters “gratin”, “stew”, “curry”, and “corn soup” indicating the product names of the other candidate products. FIG. 3 shows the product name of the candidate product displayed by a color different from that of the product names of the other candidate products as a result of the selection by the user by surrounding the product name of the candidate product selected by the user by a frame 42 of an alternate long and short dash line.

Further, if, for example, the user has touched the “candidate” button 61 in a state in which the user has selected the target product B by touching the image part of the target product B in the composite image 40, the generation unit 28 may arrange, regarding the target product B, product names of five candidate products “small salad”, “cold udon”, “croquette”, “fried chicken”, and “Korean hot pot with vegetables” in the candidate product list 50 in a descending order in accordance with the degrees of similarity. Accordingly, the user is able to select a candidate product for a target product that is not set as a priority target product by the second setting unit 26 as well.

Then, when the user touches the “confirm” button 71 of the screen 30, the product names of the target products A, B, C, and D are confirmed, and the payment processing unit 29 calculates the total amount of the products that the user purchases, for example, and performs payment processing. The payment processing unit 29 may include a function of processing sales and the content of the sales.

According to this example embodiment, it is possible to provide the product recognition system 1 in which the efficiency of operations is improved. Specifically, the second setting unit 26 calculates, for each of the target products, the difference between the degree of similarity of the first candidate product and the degree of similarity of the second candidate product, and sets a target product that satisfies a predetermined criterion based on the difference between the degrees of similarity as the priority target product. When, for example, the difference between the degree of similarity of the first candidate product and the degree of similarity of the second candidate product is equal to or smaller than a predetermined threshold regarding one target product, that is, when there is a target product in which the degree of similarity between candidate products is high regarding one target product as a result of the setting by the second setting unit 26, this target product is set as the priority target product. Alternatively, the second setting unit 26 sets a predetermined number of target products as the priority target products in, for example, ascending order in accordance with the difference between the degrees of similarity, that is, in a descending order in accordance with the degrees of similarity between candidate products. Then, the generation unit 28 generates the composite image 40 in which image parts of the priority target products are focused on and the candidate product list 50 in which the product names of the candidate products of the priority target product are arranged in such a way that one of them can be selected. If there are candidate products whose degree of similarity is high regarding one target product, it is possible that the result of the inference by the product recognition system 1 may be erroneous. On the other hand, in this example embodiment, the candidate product list 50 of the target products (priority target products) are automatically displayed on the display unit 24 in preference to the other target products. This eliminates the need for the user to perform an operation of displaying the candidate product list 50 of the above priority target products. Accordingly, it is possible to provide the product recognition system 1 in which the efficiency of operations is improved.

Further, when there are a plurality of priority target products set by the second setting unit 26, the generation unit 28 determines the priority target products that are focused on in the composite image 40 in an ascending order in accordance with the difference between the degrees of similarity calculated by the second setting unit 26. Then, the generation unit 28 further generates a composite image by switching the priority target product to be focused on every time the user selects one product name from the candidate product list 50 regarding the priority target product focused on first in the composite image 40. Further, the generation unit 28 further generates a candidate product list of a priority target product newly focused on in the composite image 40. This eliminates the need for the user to perform an operation for displaying a candidate product list of the next priority target product. Accordingly, it is possible to further improve the operability of the product recognition system 1.

Further, when a product has a plurality of sizes, the product name of the candidate product and its sizes are arranged in the candidate product list 50 in such a way that the each size of the candidate product can be selected. This eliminates the need for the user to perform an operation for causing each of the sizes of the candidate product to be displayed. It is therefore possible to provide the product recognition system 1 in which its efficiency is further improved.

Further, the product names of the candidate products are arranged in the candidate product list 50 in a descending order in accordance with the degrees of similarity in such a way that one of them can be selected. Accordingly, the user is able to first visually recognize the product name of the candidate product that is highly likely to be correct as the target product in the candidate product list 50.

Further, the generation unit 28 further generates a composite image in which, of the product names of the candidate products superimposed on the image part of the target product in the composite image 40, the color of the characters indicating the product name of the candidate product selected by the user is made different from the color of the characters indicating the product names of the other candidate products. Accordingly, the user is able to visually recognize which candidate product is the one that the user has selected in the composite image 40.

### Third Example Embodiment

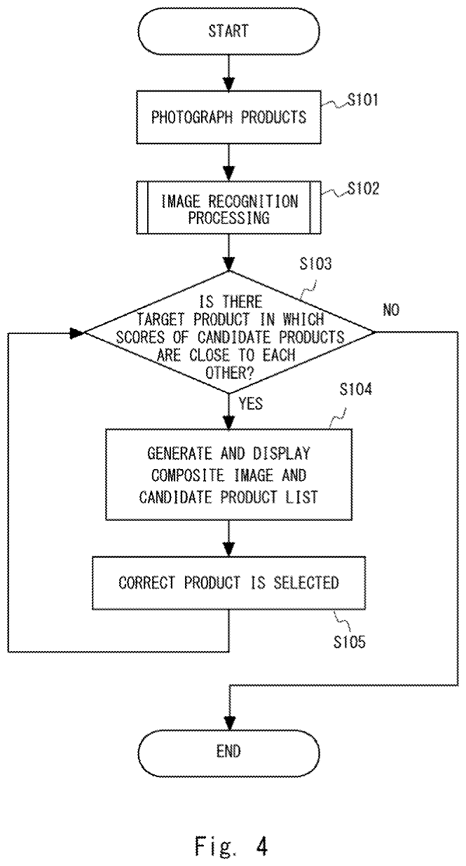

With reference to FIG. 4, a product recognition method according to a third example embodiment will be described. The product recognition method according to the third example embodiment is a method executed by the product recognition system 1 according to the present disclosure. As described above, the server-side storage unit 15 of the product recognition system 1 according to the present disclosure stores at least a reference image of a product and a product name in association with each other in advance.

First, the imaging unit 21 collectively photographs a plurality of target products to be registered and acquires an image including image parts of the plurality of target products (Step S101). The image acquired by the imaging unit 21 is transmitted to the product recognition server 10 by the terminal-side communication unit 25.

Next, the first setting unit 16 identifies the image parts of the plurality of respective target products from the image acquired in Step S101, and compares, for each of the target products, the image part of the target product with the reference image, thereby calculating the degree of similarity between the target product and the product stored in the server-side storage unit 15 (Step S102). Further, the first setting unit 16 sets, for each of the target products, a predetermined number of products as candidate products in a descending order in accordance with the degrees of similarity, and reads out the product names of the candidate products from the server-side storage unit 15. Then, the product names read out by the first setting unit 16 and the calculated degree of similarity are transmitted to the POS terminal apparatus 20 by the server-side communication unit 17.

Next, the second setting unit 26 calculates, for each of the target products, the difference between the degree of similarity of the first candidate product whose degree of similarity (score) is the highest and the degree of similarity of the second candidate product whose degree of similarity is the second highest, and determines, based on the calculated difference between the degrees of similarity, whether or not there is a target product in which the degree of similarity (score) between candidate products is high (Step S103).

In Step S103, when there is no target product in which the degree of similarity (score) between candidate products is high (Step S103; No), the processing is ended. In this case, no priority target product is set. In this case, the generation unit 28 generates a composite image in which the image parts of the plurality of target products are composed and a candidate product list in which product names of the candidate products are arranged for one of a plurality of target products in such a way that one of the product names of the candidate products can be selected, and causes the display unit 24 to display the composite image and the candidate product list.

When there is a target product in which the degree of similarity (score) between candidate products is high in Step S103 (Step S103; No), the second setting unit 26 sets a target product in which the degree of similarity between candidate products is high as a priority target product. Next, the generation unit 28 generates a composite image in which the image parts of the plurality of target products are composed in such a way that the image part of each of the priority target products is focused on, and a candidate product list in which product names of the candidate products of the priority target product are arranged in such a way that one of the them can be selected, and causes the display unit 24 to display the composite image and the candidate product list that have been generated (Step S104).

Next, when a correct product is selected from the candidate product list by the user (Step S105), the processing returns to Step S103.

### Other Example Embodiments

Next, a product recognition method according to other example embodiments will be briefly described. The product recognition method according to the other example embodiments is a method executed by the product recognition apparatus 2 according to the present disclosure. As described above, the storage unit 4 of the product recognition apparatus 2 according to the present disclosure stores at least a reference image of a product and the product name in association with each other.

First, the acquisition unit 3 acquires an image including image parts of a plurality of target products to be registered.

Next, the first setting unit 5 identifies image parts of the plurality of respective target products from the image acquired by the acquisition unit 3, and compares, for each of the target products, the image part of the target product with the reference image, thereby calculating the degree of similarity between the target product and the products stored in the storage unit 4. Further, the first setting unit 5 sets, for each of the target products, a predetermined number of products as candidate products in a descending order in accordance with the degrees of similarity, and reads out the product names of the above candidate products from the storage unit 4.

Next, the second setting unit 6 calculates the difference between the degree of similarity of the first candidate product whose degree of similarity is the highest and the degree of similarity of the second candidate product whose degree of similarity is the second highest, and determines whether or not there is a target product in which the degree of similarity between candidate products is high based on the calculated difference between the degrees of similarity.

When there is no target product in which the degree of similarity between candidate products is high, the second setting unit 6 ends this processing. In this case, no priority target product is set. Therefore, the generation unit 7 generates a composite image in which the image parts of the plurality of target products are composed and a candidate product list in which product names of the candidate products are arranged for one of a plurality of target products in such a way that one of the product names of the candidate products can be selected.

When there is a target product in which the degree of similarity between candidate products is high, the second setting unit 6 sets the target product in which the degree of similarity between candidate products is high as the priority target product.

Next, the generation unit 7 generates a composite image in which the image parts of the plurality of target products are composed in such a way that the image part of each of the priority target products is focused on, and a candidate product list in which product names of the candidate products of the priority target product are arranged in such a way that one of them can be selected. Then, after the user selects a correct product from the candidate product list in a touch panel or the like that displays the composite image, the processing goes back to the processing of checking whether or not there are candidate products whose degree of similarity is high.

While the present disclosure has been described as a hardware configuration in the aforementioned example embodiments, the present disclosure is not limited thereto. The present disclosure may achieve the processing procedure shown in the flowchart in FIG. 4 and the processing procedure described in the other example embodiments by causing a Central Processing Unit (CPU) to execute a computer program.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The first to third embodiments can be combined as desirable by one of ordinary skill in the art.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

The whole or part of the exemplary embodiments disclosed above can be described as, but not limited to, the following supplementary notes.

(Supplementary note 1)

A product recognition system comprising a product recognition server and a terminal apparatus connected to the product recognition server in such a way that they can communicate with each other, wherein

the terminal apparatus comprises:
an imaging unit configured to acquire an image including image parts of a plurality of target products to be registered; and
a terminal-side communication unit configured to transmit the image acquired by the imaging unit to the product recognition server,

the product recognition server comprises:
a server-side storage unit configured to store at least a reference image of a product and a product name in association with each other in advance;
a first setting unit configured to identify image parts of the plurality of respective target products from the image transmitted from the terminal apparatus, and compare the image part of each of the target products with the reference image, thereby calculating the degree of similarity between the target product and the product stored in the server-side storage unit, and set, for each of the target products, a predetermined number of products as candidate products in a descending order in accordance with the degrees of similarity;
a server-side communication unit configured to transmit, for each of the target products, the product names of the candidate products and the degrees of similarity to the terminal apparatus, and

the terminal apparatus further comprises:
a second setting unit configured to calculate, for each of the target products, the difference between the degree of similarity of a first candidate product whose degree of similarity is the highest and the degree of similarity of a second candidate product whose degree of similarity is the second highest, and set the target product that satisfies a predetermined criterion based on the calculated difference between the degrees of similarity as a priority target product; and
a generation unit configured to generate a composite image displayed in a predetermined part of a screen of a display unit, the composite image being generated by composing image parts of the plurality of target products in such a way that the image part of each of the priority target products is focused on, and the generation unit further generating a candidate product list displayed in another part of the screen of the display unit, the product names of the candidate products of the priority target product being arranged in the candidate product list in such a way that one of the product names of the candidate products can be selected.

### (Supplementary Note 2)

The product recognition system according to Supplementary Note 1, wherein the second setting unit sets the target product in which the difference between the degrees of similarity is equal to or smaller than a predetermined threshold as the priority target product.

### (Supplementary Note 3)

The product recognition system according to Supplementary Note 1, wherein the second setting unit sets a predetermined number of target products as the priority target products in an ascending order in accordance with the difference between the degrees of similarity.

### (Supplementary Note 4)

The product recognition system according to any one of Supplementary Notes 1 to 3, wherein

when there are a plurality of priority target products,

the generation unit determines the priority target product focused on in the composite image in an ascending order in accordance with the difference between the degrees of similarity calculated by the second setting unit, and

the generation unit further generates, regarding one of the priority target products, the composite image by switching the priority target product to be focused on every time a user selects one of the product names from the candidate product list.

### (Supplementary Note 5)

The product recognition system according to any one of Supplementary Notes 1 to 4, wherein

the terminal apparatus further comprises a terminal-side storage unit configured to store, when the product has a plurality of sizes, at least the product name and each of the sizes of the product in association with each other in advance; and

the generation unit arranges the product name of the candidate product and each of the sizes in the candidate product list in such a way that each size of the candidate product can be selected.

### (Supplementary Note 6)

The product recognition system according to any one of Supplementary Notes 1 to 5, wherein the generation unit arranges the product names of the candidate products in the candidate product list in a descending order in accordance with the degrees of similarity in such a way that one of the product names of the candidate products can be selected.

### (Supplementary Note 7)

The product recognition system according to any one of Supplementary Notes 1 to 6, wherein

the generation unit arranges, when the generation unit generates the composite image, the product names of the candidate products by superimposing them on the image part of the target product, and

the generation unit further generates a composite image in which, of the product names of the candidate products superimposed on the image part of the target product, the color of characters indicating the product name that a user has selected from the candidate product list is made different from a color of characters indicating the other product names.

### (Supplementary Note 8)

A product recognition apparatus comprising:

an acquisition unit configured to acquire an image including image parts of a plurality of target products to be registered;

a storage unit configured to store at least a reference image of a product and a product name in association with each other in advance;

a first setting unit configured to identify image parts of the plurality of respective target products from the image acquired by the acquisition unit, and compare the image part of each of the target products with the reference image, thereby calculating the degree of similarity between the target product and the product stored in the storage unit, and set, for each of the target products, a predetermined number of products as candidate products in a descending order in accordance with the degrees of similarity;

a second setting unit configured to calculate, for each of the target products, the difference between the degree of similarity of a first candidate product whose degree of similarity is the highest and the degree of similarity of a second candidate product whose degree of similarity is the second highest, and set the target product that satisfies a predetermined criterion based on the calculated difference between the degrees of similarity as a priority target product; and

a generation unit configured to generate a composite image displayed in a predetermined part of a screen of a display unit, the composite image being generated by composing image parts of the plurality of target products in such a way that the image part of each of the priority target products is focused on, and the generation unit further generating a candidate product list displayed in another part of the screen of the display unit, the product names of the candidate products of the priority target product being arranged in the candidate product list in such a way that one of the product names of the candidate products can be selected.

### (Supplementary Note 9)

The product recognition apparatus according to Supplementary Note 8, wherein the second setting unit sets the target product in which the difference between the degrees of similarity is equal to or smaller than a predetermined threshold as the priority target product.

### (Supplementary Note 10)

The product recognition apparatus according to Supplementary Note 8, wherein the second setting unit sets a predetermined number of target products as the priority target products in an ascending order in accordance with the difference between the degrees of similarity.

### (Supplementary Note 11)

The product recognition apparatus according to any one of Supplementary Notes 8 to 10, wherein

when there are a plurality of priority target products,

the generation unit determines the priority target product focused on in the composite image in an ascending order in accordance with the difference between the degrees of similarity calculated by the second setting unit, and

the generation unit further generates, regarding one of the priority target products, the composite image by switching the priority target product to be focused on every time a user selects one of the product names from the candidate product list.

### (Supplementary Note 12)

The product recognition apparatus according to any one of Supplementary Notes 8 to 11, wherein

the storage unit stores, when the product has a plurality of sizes, at least the reference image, the product name, and each of the sizes in association with one another in advance, and

the generation unit arranges the product name of the candidate product and each of the sizes in the candidate product list in such a way that each size of the candidate product can be selected.

### (Supplementary Note 13)

The product recognition apparatus according to any one of Supplementary Notes 8 to 12, wherein the generation unit arranges the product names of the candidate products in the candidate product list in a descending order in accordance with the degrees of similarity in such a way that one of the product names of the candidate products can be selected.

### (Supplementary Note 14)

The product recognition apparatus according to any one of Supplementary Notes 8 to 13, wherein

the generation unit arranges, when the generation unit generates the composite image, the product names of the candidate products by superimposing them on the image part of the target product, and

the generation unit further generates a composite image in which, of the product names of the candidate products superimposed on the image part of the target product, the color of characters indicating the product name that a user has selected from the candidate product list is made different from a color of characters indicating the other product names.

### (Supplementary Note 15)

A product recognition method, wherein

a product recognition apparatus performs the following processing of:

acquiring an image including image parts of a plurality of target products to be registered;

storing at least a reference image of a product and a product name in association with each other in advance;

identifying image parts of the plurality of perspective target products from the acquired image, and comparing, for each of the target products, the image part of the target product with the reference image, thereby calculating the degree of similarity between the target product and the product stored in advance, and setting, for each of the target products, a predetermined number of products as candidate products in a descending order in accordance with the degrees of similarity;

calculating, for each of the target products, the difference between the degree of similarity of a first candidate product whose degree of similarity is the highest and the degree of similarity of a second candidate product whose degree of similarity is the second highest, and setting the target product that satisfies a predetermined criterion based on the calculated difference between the degrees of similarity as a priority target product; and

generating a composite image displayed in a predetermined part of a screen of a display unit, the composite image being generated by composing image parts of the plurality of target products in such a way that the image part of each of the priority target products is focused on, and a candidate product list displayed in another part of the screen of the display unit, the product names of the candidate products of the priority target product being arranged in the candidate product list in such a way that one of the product names of the candidate products can be selected.

### (Supplementary Note 16)

The product recognition method according to Supplementary Note 15, wherein the product recognition apparatus sets the target product in which the difference between the degrees of similarity is equal to or smaller than a predetermined threshold as the priority target product.

### (Supplementary Note 17)

The product recognition method according to Supplementary Note 15, wherein the product recognition apparatus sets a predetermined number of target products as the priority target products in an ascending order in accordance with the difference between the degrees of similarity.

### (Supplementary Note 18)

The product recognition method according to any one of Supplementary Notes 15 to 17, wherein

when there are a plurality of priority target products,

the product recognition apparatus determines the priority target products focused on in the composite image in an ascending order of the calculated difference between the degrees of similarity, and

the product recognition apparatus further generates, regarding one of the priority target products, the composite image by switching the priority target product to be focused on every time a user selects one of the product names from the candidate product list.

### (Supplementary Note 19)

The product recognition method according to any one of Supplementary Notes 15 to 18, wherein

the product recognition apparatus stores, when the product has a plurality of sizes, at least the reference image, the product name, and each of the sizes in association with one another in advance, and

the product recognition apparatus arranges the product names of the candidate products in the candidate product list in such a way that each size of the candidate product can be selected.

### (Supplementary Note 20)

The product recognition method according to any one of Supplementary Notes 15 to 19, wherein the product recognition apparatus arranges the product names of the candidate products in the candidate product list in a descending order in accordance with the degrees of similarity in such a way that one of the product names of the candidate products can be selected.

### (Supplementary Note 21)

The product recognition method according to any one of Supplementary Notes 15 to 20, wherein

the product recognition apparatus arranges, when the product recognition apparatus generates the composite image, the product names of the candidate products by superimposing them on the image part of the target product, and

the product recognition apparatus further generates a composite image in which, of the product names of the candidate products superimposed on the image part of the target product, the color of characters indicating the product name that a user has selected from the candidate product list is made different from a color of characters indicating the other product names.

### (Supplementary Note 22)

A product recognition program for causing a product recognition apparatus to execute the processing of:

acquiring an image including image parts of a plurality of target products to be registered;

storing at least a reference image of a product and a product name in association with each other in advance;

identifying image parts of the plurality of perspective target products from the acquired image, and comparing, for each of the target products, the image part of the target product with the reference image, thereby calculating the degree of similarity between the target product and the product that has been stored in advance, and setting, for each of the target products, a predetermined number of products as candidate products in a descending order in accordance with the degrees of similarity;

calculating, for each of the target products, the difference between the degree of similarity of a first candidate product whose degree of similarity is the highest and the degree of similarity of a second candidate product whose degree of similarity is the second highest, and setting the target product that satisfies a predetermined criterion based on the calculated difference between the degrees of similarity as a priority target product; and

generating a composite image displayed in a predetermined part of a screen of a display unit, the composite image being generated by composing image parts of the plurality of target products in such a way that the image part of each of the priority target products is focused on, and a candidate product list displayed in another part of the screen of the display unit, the product names of the candidate products of the priority target product being arranged in the candidate product list in such a way that one of the product names of the candidate products can be selected.

### (Supplementary Note 23)

The product recognition program according to Supplementary Note 22, causing the product recognition apparatus to execute processing of setting the target product in which the difference between the degrees of similarity is equal to or smaller than a predetermined threshold as the priority target product.

### (Supplementary Note 24)

The product recognition program according to Supplementary Note 22, causing the product recognition apparatus to execute processing of setting a predetermined number of target products as the priority target products in an ascending order in accordance with the difference between the degrees of similarity.

### (Supplementary Note 25)

The product recognition program according to any one of Supplementary Notes 22 to 24, causing the product recognition apparatus to execute,

when there are a plurality of priority target products,

in the processing of generating the composite image,

determining the priority target products focused on in the composite image in an ascending order of the calculated difference between the degrees of similarity, and

further generating, regarding one of the priority target products, the composite image by switching the priority target product to be focused on every time a user selects one of the product names from the candidate product list.

### (Supplementary Note 26)

The product recognition program according to any one of Supplementary Notes 22 to 25, causing the product recognition apparatus to execute:

storing, when the product has a plurality of sizes, at least the reference image of the product, the product name, and each of the sizes in association with one another in advance, and

arranging the product names of the candidate products in the candidate product list in such a way that each size of the candidate product can be selected.

### (Supplementary Note 27)

The product recognition program according to any one of Supplementary Notes 22 to 26, causing the product recognition apparatus to execute processing of arranging the product names of the candidate products in the candidate product list in a descending order in accordance with the degrees of similarity in such a way that one of them can be selected.

### (Supplementary Note 28)

The product recognition program according to any one of Supplementary Notes 22 to 27, causing the product recognition apparatus to execute the processing of:

arranging the product names of the candidate products by superimposing them on the image part of the target product in the processing of generating the composite image; and

further generating a composite image in which, of the product names of the candidate products superimposed on the image part of the target product, the color of characters indicating the product name that a user has selected from the candidate product list is made different from a color of characters indicating the other product names.

What is claimed is:

1. A product recognition system comprising a product recognition server and a terminal apparatus connected to the product recognition server in such a way that they can communicate with each other, wherein
the terminal apparatus comprises:
an imaging unit configured to acquire an image including image parts of a plurality of target products to be registered; and
a terminal-side communication unit configured to transmit the image acquired by the imaging unit to the product recognition server,
the product recognition server comprises:
a server-side storage unit configured to store at least a reference image of a product and a product name in association with each other in advance;
a first setting unit configured to identify the image parts of the plurality of respective target products from the image transmitted from the terminal apparatus, and compare the image part of each of the target products with the reference image, thereby calculating the degree of similarity between the target product and the product stored in the server-side storage unit, and set, for each of the target products, a predetermined number of products as candidate products in a descending order in accordance with the degrees of similarity;
a server-side communication unit configured to transmit, for each of the target products, the product names of the candidate products and the degrees of similarity to the terminal apparatus, and
the terminal apparatus further comprises:
a second setting unit configured to calculate, for each of the target products, the difference between the degree of similarity of a first candidate product whose degree of similarity is the highest and the degree of similarity of a second candidate product whose degree of similarity is the second highest, and set the target product that satisfies a predetermined criterion based on the calculated difference between the degrees of similarity as a priority target product; and
a generation unit configured to generate a composite image displayed in a predetermined part of a screen of a display unit, the composite image being generated by composing image parts of the plurality of target products in such a way that the image part of each of the priority target products is focused on, and the generation unit further generating a candidate product list displayed in another part of the screen of the display unit, the product names of the candidate products of the priority target product being arranged in the candidate product list in such a way that one of the product names of the candidate products can be selected.

2. The product recognition system according to claim 1, wherein the second setting unit sets the target product in which the difference between the degrees of similarity is equal to or smaller than a predetermined threshold as the priority target product.

3. The product recognition system according to claim 1, wherein the second setting unit sets a predetermined number of target products as the priority target products in an ascending order in accordance with the difference between the degrees of similarity.

4. The product recognition system according to claim 1, wherein
when there are a plurality of priority target products,
the generation unit determines the priority target product focused on in the composite image in an ascending order in accordance with the difference between the degrees of similarity calculated by the second setting unit, and
the generation unit further generates, regarding one of the priority target products, the composite image by switching the priority target product to be focused on every time a user selects one of the product names from the candidate product list.

5. The product recognition system according to claim 1, wherein
the terminal apparatus further comprises a terminal-side storage unit configured to store, when the product has a plurality of sizes, at least the product name and each of the sizes of the product in association with each other in advance; and
the generation unit arranges the product name of the candidate product and each of the sizes in the candidate product list in such a way that each size of the candidate product can be selected.

6. The product recognition system according to claim 1, wherein the generation unit arranges the product names of the candidate products in the candidate product list in a descending order in accordance with the degrees of similarity in such a way that one of the product names of the candidate products can be selected.

7. The product recognition system according to claim 1, wherein
the generation unit arranges, when the generation unit generates the composite image, the product names of the candidate products by superimposing them on the image part of the target product, and
the generation unit further generates a composite image in which, of the product names of the candidate products superimposed on the image part of the target product, the color of characters indicating the product name that a user has selected from the candidate product list is made different from a color of characters indicating the other product names.

8. A product recognition apparatus comprising:
an acquisition unit configured to acquire an image including image parts of a plurality of target products to be registered;
a storage unit configured to store at least a reference image of a product and a product name in association with each other in advance;
a first setting unit configured to identify the image parts of the plurality of respective target products from the image acquired by the acquisition unit, and compare the image part of each of the target products with the reference image, thereby calculating the degree of similarity between the target product and the product stored in the storage unit, and set, for each of the target products, a predetermined number of products as candidate products in a descending order in accordance with the degrees of similarity;
a second setting unit configured to calculate, for each of the target products, the difference between the degree of similarity of a first candidate product whose degree of similarity is the highest and the degree of similarity of a second candidate product whose degree of similarity is the second highest, and set the target product that satisfies a predetermined criterion based on the calculated difference between the degrees of similarity as a priority target product; and
a generation unit configured to generate a composite image displayed in a predetermined part of a screen of a display unit, the composite image being generated by composing the image parts of the plurality of target products in such a way that the image part of each of the priority target products is focused on, and the generation unit further generating a candidate product list displayed in another part of the screen of the display unit, the product names of the candidate products of the priority target product being arranged in the candidate product list in such a way that one of the product names of the candidate products can be selected.

9. The product recognition apparatus according to claim 8, wherein the second setting unit sets the target product in which the difference between the degrees of similarity is equal to or smaller than a predetermined threshold as the priority target product.

10. The product recognition apparatus according to claim 8, wherein the second setting unit sets a predetermined number of target products as the priority target products in an ascending order in accordance with the difference between the degrees of similarity.

11. The product recognition apparatus according to claim 8, wherein
when there are a plurality of priority target products,
the generation unit determines the priority target product focused on in the composite image in an ascending order in accordance with the difference between the degrees of similarity calculated by the second setting unit, and
the generation unit further generates, regarding one of the priority target products, the composite image by switching the priority target product to be focused on every time a user selects one of the product names from the candidate product list.

12. The product recognition apparatus according to claim 8, wherein
the storage unit stores, when the product has a plurality of sizes, at least the reference image, the product name, and each of the sizes in association with one another in advance, and
the generation unit arranges the product name of the candidate product and each of the sizes in the candidate product list in such a way that each size of the candidate product can be selected.

13. A product recognition method, wherein
a product recognition apparatus performs the following processing of:
acquiring an image including image parts of a plurality of target products to be registered;
storing at least a reference image of a product and a product name in association with each other in advance;
identifying image parts of the plurality of perspective target products from the acquired image, and comparing, for each of the target products, the image part of the target product with the reference image, thereby calculating the degree of similarity between the target product and the product stored in advance, and setting, for each of the target products, a predetermined number of products as candidate products in a descending order in accordance with the degrees of similarity;
calculating, for each of the target products, the difference between the degree of similarity of a first candidate product whose degree of similarity is the highest and the degree of similarity of a second candidate product whose degree of similarity is the second highest, and setting the target product that satisfies a predetermined criterion based on the calculated difference between the degrees of similarity as a priority target product; and
generating a composite image displayed in a predetermined part of a screen of a display unit, the composite image being generated by composing image parts of the plurality of target products in such a way that the image part of each of the priority target products is focused on, and a candidate product list displayed in another part of the screen of the display unit, the product names of the candidate products of the priority target product being arranged in the candidate product list in such a way that one of the product names of the candidate products can be selected.

14. The product recognition method according to claim 13, wherein the product recognition apparatus sets the target product in which the difference between the degrees of similarity is equal to or smaller than a predetermined threshold as the priority target product.

15. The product recognition method according to claim 13, wherein the product recognition apparatus sets a predetermined number of target products as the priority target products in an ascending order in accordance with the difference between the degrees of similarity.

16. The product recognition method according to claim 13, wherein
when there are a plurality of priority target products,
the product recognition apparatus determines the priority target products focused on in the composite image in an ascending order of the calculated difference between the degrees of similarity, and
the product recognition apparatus further generates, regarding one of the priority target products, the composite image by switching the priority target product to be focused on every time a user selects one of the product names from the candidate product list.
